(19) United States
(12) Patent Application Publication
(10) Pub. No.: US 2011/0100862 A1
(43) Pub. Date: May 5, 2011

(54) DISPENSING APPARATUS WITH MONITORING SYSTEM FOR BLISTER PACKS

(75) Inventors: William Bradford Turkington, Co. Londonderry (GB); Thomas Krivda, Wien (AT); Andrew Jones, Leicestershire (GB)

(73) Assignee: AUDIO INTERNATIONAL LTD., Co. Londonderry (GB)

(21) Appl. No.: 12/812,769

(22) PCT Filed: Jan. 15, 2009
(86) PCT No.: PCT/EP2009/000207

§ 371 Date: Jan. 14, 2011

(30) Foreign Application Priority Data
Jan. 15, 2008 (GB) 0800658.7

(51) Int. Cl. A61J 1/03; A61J 7/04; G08B 21/00

(52) U.S. Cl. 206/531; 206/534; 340/540

(57) ABSTRACT

A dispensing apparatus comprising a case (20) and a removable package (10), for example a blister pack. The package (10) has compartments (12) and a film (11) of frangible material extending across the mouth of the compartments (12) in order to close the compartments (12). An electrically conductive track (16) is provided on the external face of the film (11) and has segments that traverse at least partly across the compartments (12). The case (20) includes a connector (22) for receiving the package (10) and means for electrically connecting, when the package (10) is inserted, the conductive track (16) to a monitoring system located in the case (20). The monitoring system includes means for monitoring the electrical signals from the conductive track, and means for determining that a respective compartment (12) has been opened upon depending on the monitored electrical signals.

### FIELD OF THE INVENTION

The present invention relates to dispensing apparatus for monitoring the usage of blister packs and similar packages.

### BACKGROUND TO THE INVENTION

Medication in the form of pills is often provided in blister packs. The pills are intended to be taken by a patient in accordance with a prescribed regime.

A problem with conventional blister packs is that the patient's healthcare provider cannot readily monitor whether or not the prescribed regime has been followed by the patient. In addition, patients with visual impairments, reading difficulties, memory impairments or who do not speak the local language may experience difficulties in complying with the prescribed regime.

It would be desirable to mitigate the problems outlined above.

### SUMMARY OF THE INVENTION

A first aspect of the invention provides a dispensing apparatus comprising a case and a removable package, the package comprising at least one compartment and a film of frangible material extending across an open mouth of the or each compartment in order to close the compartment, wherein at least one electrically conductive track is provided on the external face of the film and traverses at least partly across the or each compartment, the case including a connector for receiving said package and means for electrically connecting, when said package is received by said connector, said at least one conductive track to a monitoring system located in said case, wherein said monitoring system includes means for monitoring electrical signals received from said at least one conductive track, and means for determining, from said electrical signals, whether or not said at least one compartment has been opened.

It will be understood that the case and the package may be provided independently of one another and, as such, each comprises a respective further aspect of the invention.

At least one layer of electrically insulating material is preferably provided between the film and the conductive track(s). Preferably, at least one layer of electrically insulating material is provided on top of the conductive track(s).

The conductive track is advantageously formed from a flexible and frangible material. The conductive track is preferably formed from a conductive flexographic ink. The or each insulating layer is preferably formed from an insulating flexographic ink.

The conductive track(s) typically includes at least one electrical terminal for connecting the conductive track(s) to one or more electrical circuits. In the preferred embodiment the package includes a plurality of compartments and a single conductive track is shaped to traverse each compartment, the conductive track having at least one terminal for connecting it to an electrical circuit. Preferably still, the conductive track includes a common terminal from which a common rail emanates, and a respective branch section emanating from the common rail to traverse a respective compartment, each branch having a respective terminal for connection to the electrical circuit. Conveniently, the terminals are arranged substantially linearly, i.e. in a row, preferably at or adjacent an edge of the package.

Another aspect of the invention provides a package, especially a blister pack, comprising at least one compartment and a film of frangible material extending across an open mouth of the or each compartment in order to seal the compartment, wherein at least one electrically conductive track is provided on the external face of the film and traversing at least partly across the or each compartment, and wherein at least one layer of electrically insulating material is preferably provided between the film and the conductive track(s).

A further aspect of the invention provides a case for receiving the package of said another aspect of the invention, the case including a connector for receiving said package and means for electrically connecting the or each terminal of the package to a monitoring system provided in the case. The monitoring system preferably includes means for monitoring electrical signals received from the conductive track(s).

The case preferably also includes means for playing audio messages.

The connector preferably includes means for releasably holding, preferably releasably clamping, the package in the connector.

In the preferred embodiment, the connector is provided on a spine portion of the case, the case including two leaf portions coupled to the spine and operable in to and out of a closed state in which the package, when installed, is contained within the leaf portions. Preferably, each leaf portion is pivotably coupled to a respective side of the spine, the spine typically being substantially centrally located between the leaf portions.

A still further aspect of the invention provides a method for monitoring usage of said package aspect of the invention, the method comprising monitoring electrical signals received from one or more segments of the conductive track; determining from said electrical signals whether or not said at least one compartment is open; and, preferably, recording information relating to whether or not said at least one compartment is determined to be open, especially the time and/or date at which said at least one compartment is determined to be open.

The preferred blister pack and case allow information that would conventionally be carried by, say, a patient information leaflet to be presented in audio format, to prompt correct compliance with a prescription schedule and to record compliance data to allow monitoring. This enables people with visual impairments, reading difficulties, memory impairments or who do not speak the local language to better understand their medication and comply with the prescription. It also allows the healthcare providers to understand how well the prescribed schedule has been complied with.

In typical embodiments, the exterior of the case consists of a series of thermoplastic injection mouldings, including a hinge, clasp and speaker grill. The casing covers are advantageously designed to be moulded from a single mould tool, thereby reducing tooling cost. The covers support and protect the other components of the case, including, preferably, the non-slip backing panel, a front control panel and electronic monitoring, speech and control systems, ensuring the device is portable and robust. Also, to facilitate compliance monitoring and to provide an alert system it is necessary to be able to electronically monitor when a pill has been removed from the blister pack.

Preferred features of the invention are recited in the dependent claims. Further advantageous aspects of the invention will be apparent from the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1A is a plan view of a package, in the preferred form of a blister pack, embodying one aspect of the invention;

FIG. 1B shows the package in side view;

FIG. 2 is a perspective view of the blister pack of FIG. 1 connected to a case, the case embodying a second aspect of the invention;

FIG. 3 is an alternative perspective view of the case and blister pack of FIG. 2;

FIG. 4 is a sectioned side view of the case and blister pack when in an open state;

FIG. 5 is a sectioned side view of the case and blister pack when in a closed state;

FIG. 6 is a side elevation of the blister pack connected to the case;

FIG. 7 is an end elevation of the blister pack and part of the case shown in FIGS. 2 to 6;

FIG. 8 is a perspective view of the case when in the closed state; and

FIG. 9 is a block diagram illustrating an example of a monitoring system that may be used in the implementation of the preferred functionality of the case.

### DETAILED DESCRIPTION OF THE DRAWINGS

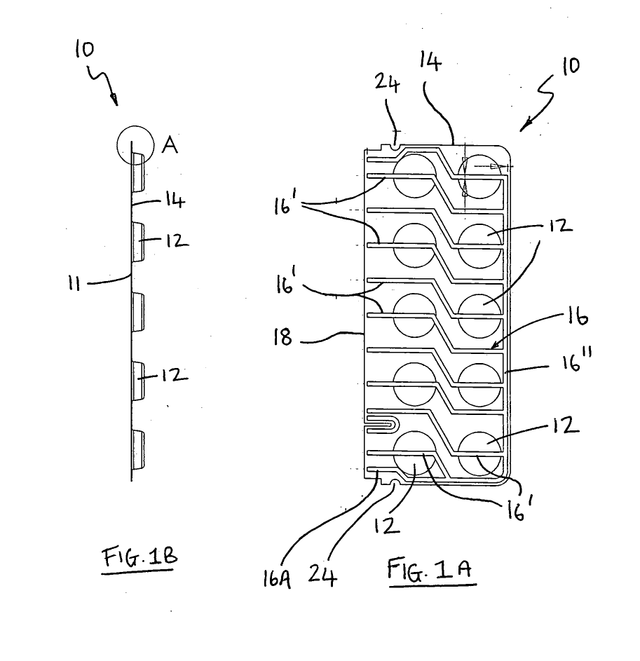

Referring now in particular to FIG. 1 of the drawings, there is shown generally indicated as 10, a package embodying a first aspect of the invention. The package 10 comprises a number of compartments 12 for receiving a packaged item, for example a pill (not shown). The compartments 12 typically take the form of cavities formed in a sheet 14 of material, usually plastics material. A frangible film 11 is provided over the sheet 14 in order to close the compartments 12. The film 11 is adhered, bonded or otherwise fixed to the sheet 14 in any convenient manner. The film 11 is often formed from foil, for example aluminium foil, but may be formed from other suitable materials, e.g. plastics or laminated material. In use, by applying pressure to the external surface of the compartments 12, the item inside the compartment 12 is forced against the respective portion of the film 11, causing it to rupture thereby allowing the item to be dispensed through the mouth of its compartment 12. Packages of the general type described above and illustrated in FIG. 1 are commonly referred to as blister packs. Typically, each blister pack will comprise a plurality of compartments 12, or blisters, although in some cases the pack may comprise a single compartment/blister.

In some applications, for example where the compartments 12 contain medication, to facilitate compliance monitoring it is desirable to be able to monitor when a pill has been removed from the blister pack 10. To enable this, an electrically conductive track 16 is provided on the blister pack 10. In preferred embodiments, the conductive track 16 is provided on the external surface of the film 11.

The arrangement is such that a respective segment of conductive track 16 is in register with each of the compartments 12. Preferably, each segment of the track 16 is in register with only one respective compartment 12. Conveniently, the track 16 comprises a plurality of branch segments 16′ extending from a common rail segment 16″, each branch segment 16′ being arranged to wholly or partly traverse a respective compartment 12. The conductive track 16 is frangible so that it may be broken or ruptured when the corresponding portion of film 11 is ruptured. In alternative embodiments, a separate conductive track (not shown) may be provided for each compartment 12, or respective groups of two or more compartments.

In use, the conductive track 16 forms part of an electrical circuit which may be used to monitor when the film 11 is ruptured by the expulsion of a pill, or other item, from its compartment 12. This may be achieved by monitoring electrical signals received from the track 16 during use. For example, this may be achieved by monitoring a change in the electrical resistance of the track 16, although one or more other electrical properties or signals could be monitored instead, or in addition.

In preferred embodiments, each branch segment 16′ terminates in a free end, or terminal. More preferably, each of the free ends of the branches 16′ are advantageously arranged to be located at, or adjacent, an edge 18 of the blister pack 10. The preferred arrangement is such that the free ends are arranged in a row, conveniently along a side of the pack 10 substantially with respect to one another.

In many cases, the film 11 is formed from an electrically conductive material. In such cases, it is necessary to electrically insulate the conductive track 16 from the film 11. In preferred embodiments, therefore, at least one layer of electrically insulating material is provided between the conductive track 16 and the film 11. The, or each, insulating layer (not shown) may be shaped to match, or substantially match, the shape of the conductive track 16. Conveniently, however, the insulating layer(s) are applied directly or indirectly to the external surface of the film, covering either the entire area of the film or at least those portions of the film on to which the conductive track will be laid. Optionally, a layer of priming material (not shown), for example lacquer, may be provided on top of the film 11 beneath the insulating layer(s).

By way of example, the widths of the track may be between 0.75 mm and 1.5 mm.

Preferably, at least one additional layer of electrically insulating material is provided on top of the conductive track 16. This ensures that the film 11, when ruptured and peeled back, does not cause a short circuit between portions of the conductive track 16.

The conductive track 16 is formed from a flexible and frangible electrically conductive material. In preferred embodiments, the conductive track is formed from electrically conductive ink, and in particular conductive flexographic ink. Suitable ink is available from, for example, Fint Inks, Hostmann-Steinberg and Sicpa. The electrically insulating layer(s) may be formed from insulative inks, especially conventional conductive flexographic inks. The provision of the conductive track 16 and/or insulating layer(s) may be performed using any suitable means, for example flexographic printing.

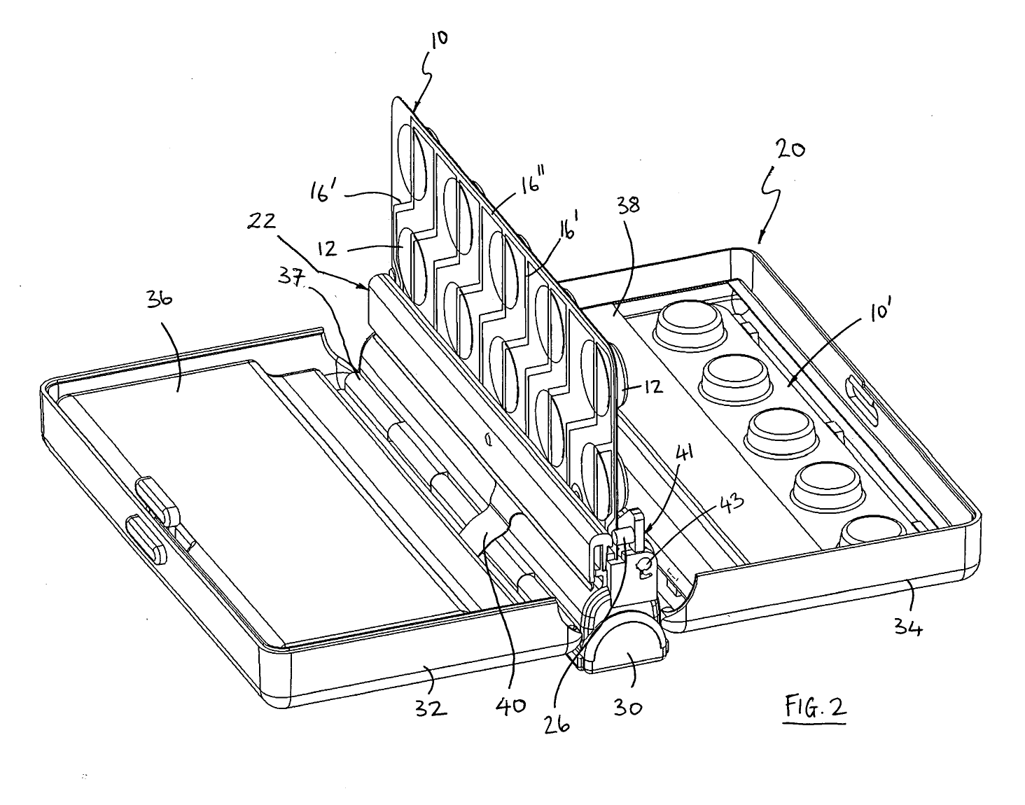

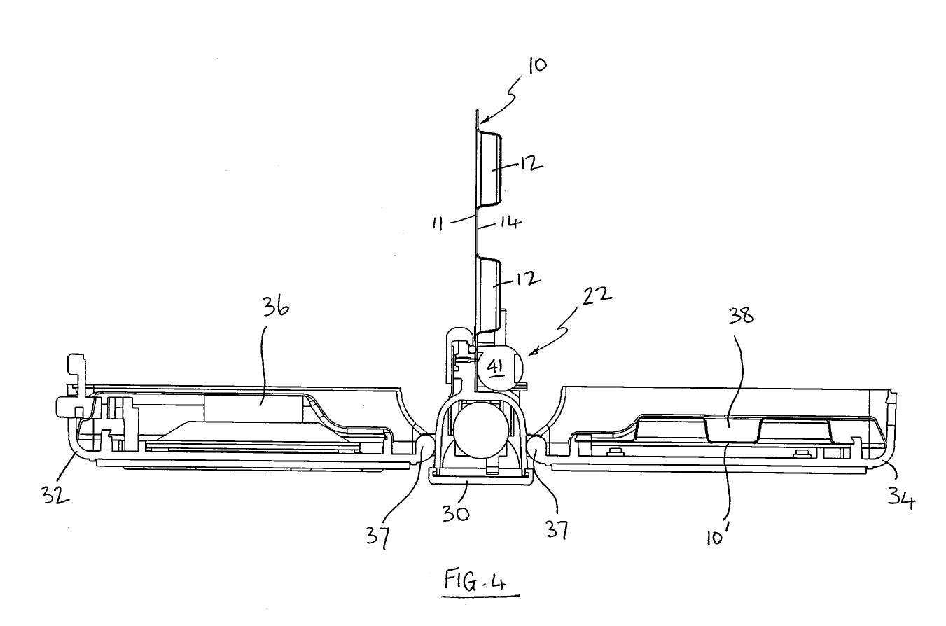

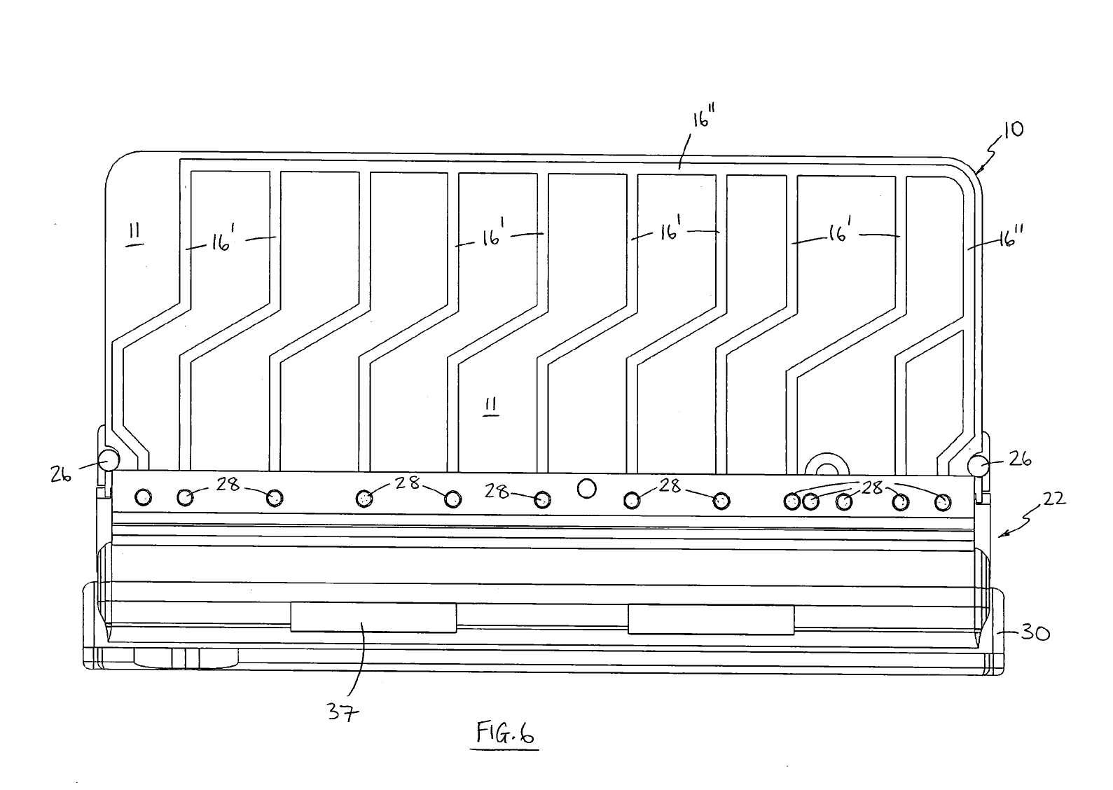

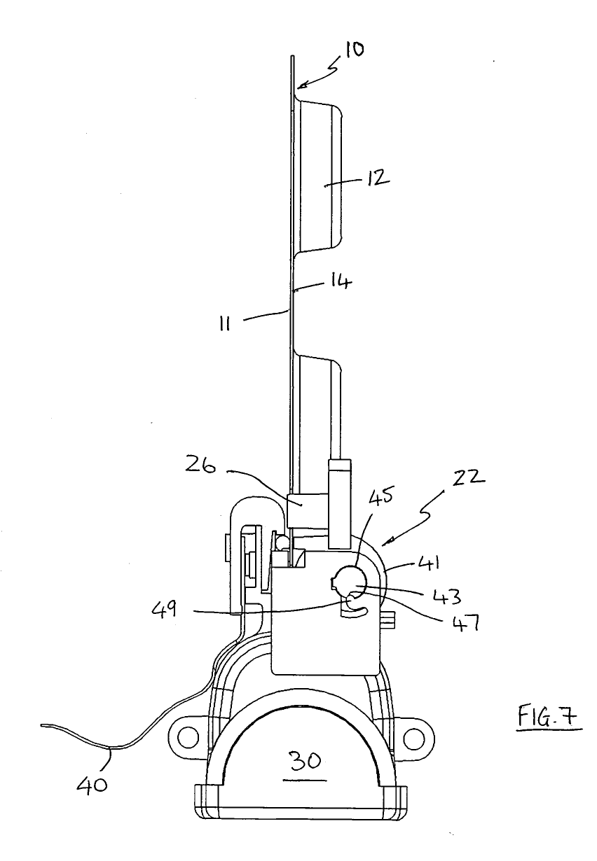

Referring now in particular to FIGS. 2 to 8, there is shown a case 20 adapted for use with the blister pack 10. The case 20 and the blister pack 10 together serve as a dispensing apparatus. The case 20 includes a connector 22 adapted to receive the blister pack 10. In the preferred embodiment, the connector 22 takes the form of a socket adapted to receive the end of the blister pack 10 that terminates at edge 18. Advantageously, means for holding the blister pack 10 in a socket are provided. Preferably, means for positioning the blister pack 10 with respect to the connector 22 are provided. By way of example, the positioning means may include one or more notches 24, or apertures, formed in the blister pack 10 and one or more corresponding pins 26 provided on or adjacent the connector 22.

The case 20 may include a rotatable cam shaped to provide several possible locating features when in a closed and locked position to resist the removal of the blister pack 10 from the case 20. The holding means may include opposing clamping faces arranged to clamp the blister pack 10 at or adjacent its edge 18, along all or part of its length.

In the illustrated embodiment, the blister pack holding means includes a clamping member 41 that is rotatably mounted at both of its ends with respect to the case 20 and, more particularly in the preferred embodiment, with respect to a spine portion 30 of the case 20. Conveniently, the clamping member 41 includes a respective axle portion 43 at each end, the axle portions 43 being rotatably mounted in a respective bush 45 provided at opposite ends of the spine 30. The clamping member 41 is rotatable about its longitudinal axis between a clamping state (for example as shown in FIGS. 2, 3, 4 and 7) in which it engages with the blister pack 10 (in the present example along the length of the blister pack 10 adjacent the edge 18), and a non-clamping state in which the blister pack 10 is free to be inserted into or removed from the connector 22. Preferably, a positive locating mechanism is provided to hold the clamping member 41 in its clamping state. By way of example, this is achieved by providing one or more notches 47 in the axles 43 and a cooperating resilient latch member 49 at the bushing 45. The arrangement is such that the respective latch 49 and notch 47 are in engagement when the clamping member 41 is in its closed state. The inter-engagement of the latch 49 and the notch 47 provides a resistance to the clamping member 41 moving out of its clamping state. However, because of the resilience of the latch member 49, this resistance can readily be overcome by, for example, a user pushing the clamping member 41 out of the clamping state. The notch and latch arrangement may be provided on either or both ends of the clamping member 41. In the illustrated embodiment, the clamping member 41 carries the pins 26.

The connector 22 includes a respective electrical terminal 28 for each of the free ends of the branch sections 16′ of the conductive track 16. When the blister pack 10 is correctly inserted in to the connector 22, the respective terminals 28 and free ends of the pack segments 16′ make an electrical connection with one and other and complete an electrical circuit by which the electrical resistance of the track segments can be monitored.

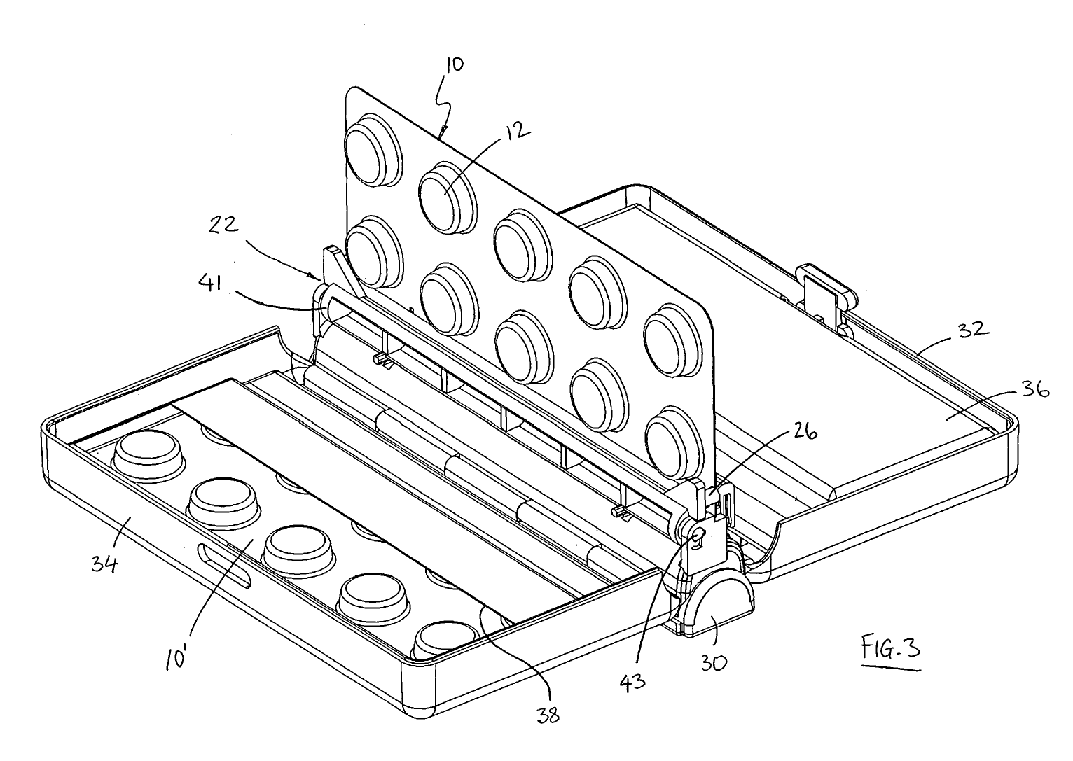

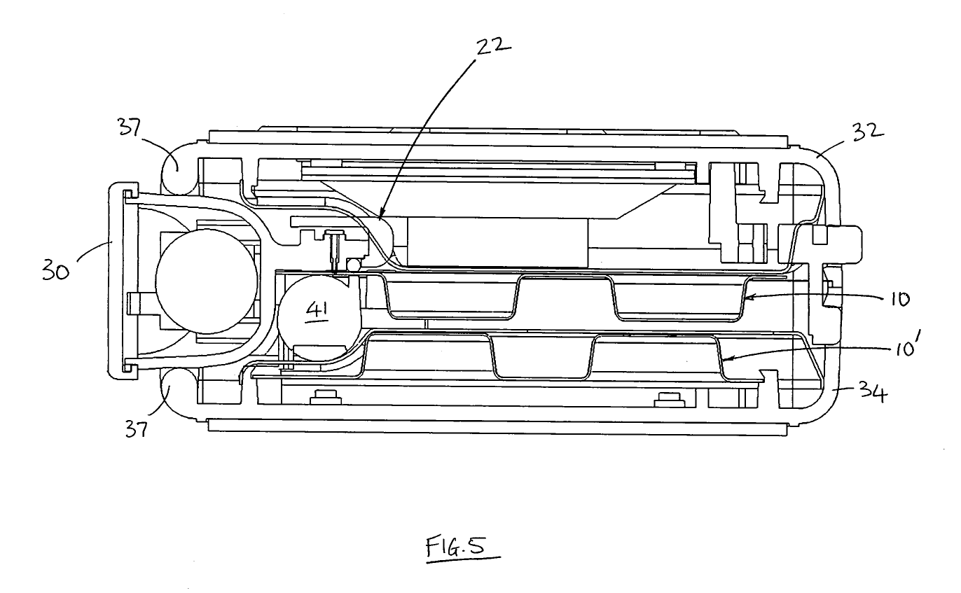

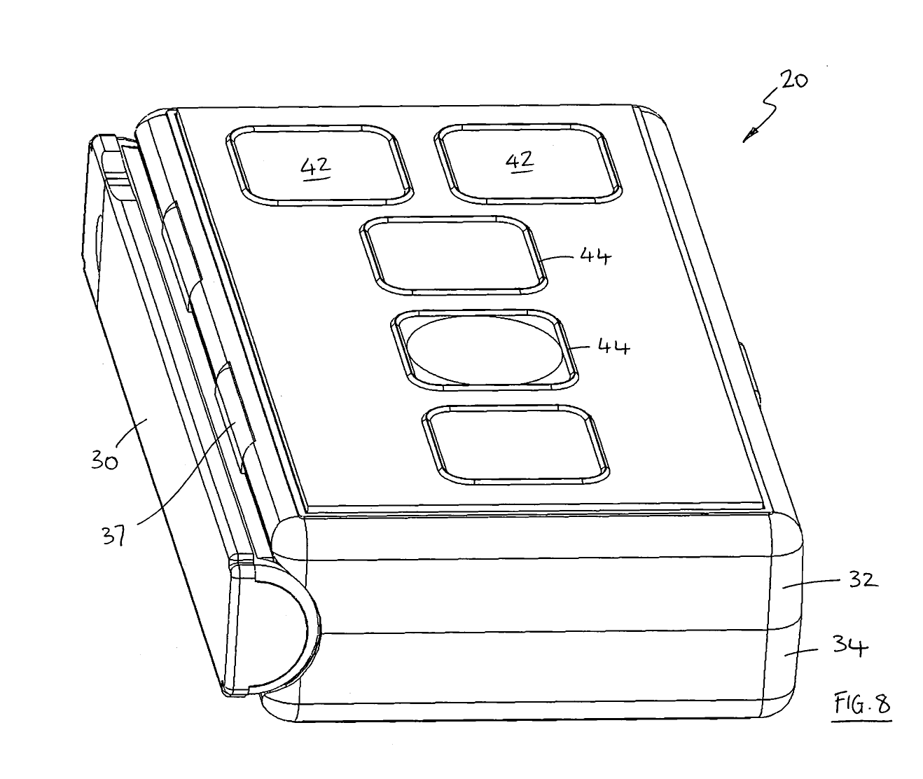

In the preferred embodiment, the case 20 includes the spine portion 30 with a respective leaf portion 32, 34 at either side. The leaf portions 32, 34 are operable between an open state (as shown for example in FIGS. 2 and 3) and a closed state (as shown for example in FIGS. 5 and 8). In the open state, the blister pack 10, when installed, is exposed to the user, while in the closed state, the leaf portions 32 and 34 come together to form a closed or substantially closed casing around the blister pack 10. At least one but preferably each portion 32, 34 is pivotably coupled to the spine portion 30, for example by means of a suitable hinge 37.

This preferred arrangement allows each of the leaf portions 32, 34 to be actuated away from the blister pack 10 into the open state to allow each face of the blister pack 10 to be exposed to the user. In a particularly preferred arrangement, the case 20 is arranged to hold the blister pack 10, when inserted, in a first plane, each of the leaves 32, 34 being disposed substantially parallel with said first plane when in the closed state. Preferably still, when in the open state, the leaf portions 32, 34 are disposed in a plane that is substantially perpendicular with said first plane. In the preferred embodiment, the connector 22 is provided on the spine portion 30. In its open state, the case 20 facilitates the location, insertion and removal of blister packs 10 without sight and may include a locating wedge and a relatively wide opening for the connector 22.

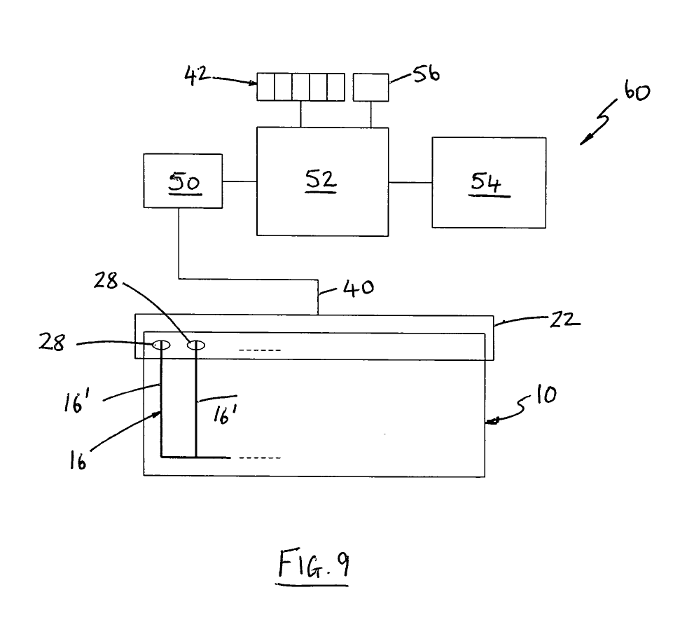

A compartment 36 may be provided at least one of the leaves 32, 34, for housing a monitoring system 60 (FIG. 9) typically comprised of electrical and/or electronic circuitry. The monitoring system 60 includes means for monitoring electrical signals received from the conductive track 16, and means for determining, from said electrical signals, whether or not one or more of the compartments 12 has been opened. In particular, the preferred monitoring means monitors at least one respective electrical signal received from each respective conductive track segment 16′, and said determining means determines whether or the respective compartment has been opened from the respective electrical signal(s). For example, the monitoring system may include means for forming an electrical circuit with said conductive track 16 via said connector 22, and means for detecting changes in the electrical resistance (or other electrical property) of the conductive track 16, and in particular changes in the respective electrical resistance (or other electrical property) of each of the branch segments 16′.

An electrical power supply (not shown), typically in the form of a battery, is also provided to supply power to the electrical/electronic circuitry. The system may also include means for recording the date and/or time at which detected changes in electrical resistance occur. The case 20 may also be provided with a communication port, for example a USB port, to enable an external device, typically a computer, to communicate with the electronic circuitry housed in the case 20.

One or other of the leaves 32, 34 may include a compartment 38 for storing one or more other blister packs 10′.

In FIG. 2, an electrical cable 40 is shown for providing an electrical connection between the monitoring system in the compartment 36 and the terminals 28 in the connector 22.

Conveniently, the electrical power supply of the monitoring system 60 is arranged to supply electrical power to the track 16 when the blister pack 10 is inserted into the connector 22. In the illustrated embodiment, this is achieved via a common terminal on a supply branch 16A of the track 16, by which power may be supplied to the rail 16″, the segments 16′ providing respective return paths to complete the circuit. Hence, the segments 16′ are electrically connected in parallel with one another.

The monitoring system may also include means for storing and playing audio messages, for example a digital audio player and associated memory (not shown). The audio player is programmable to play any suitable messages, for example instructions for taking medication and/or a description of the medication. In the preferred embodiment, controls for operating the audio player are provided on the external surface of the case 20. This may be seen in FIG. 8 which shows a number of control buttons 42, for example in the form of membrane buttons that are co operable with the audio player which, itself, is conveniently located in the compartment 36. The texture, shape, size, icons, position and/or colours of the buttons are advantageously selected to be identifiable by people with low or no vision. For example, it is preferred to provide a raised rim 44 around each button. Advantageously a mechanical clicking device is located beneath each button to provide an audible and tactile confirmation that the button has been activated.

The monitoring system may also include means for generating one or more alarms, e.g. audio and/or visual alarms depending on the detected activity at the installed blister pack 10. For example, if the system determines that a pill has been taken incorrectly or not taken at all, then a suitable alarm may be generated. The audio alarm(s) may for example be generated by the audio player. A visual alarm may be generated by any suitable means, for example the provision of one or more LEDs (not shown).

FIG. 9 illustrates an example of the monitoring system 60, and shows the blister pack 10 connected to the connector 22. The system 60 includes a device 50 that is electrically connected to the track 16 via cable 40 and electrical terminals 28. The device 50 monitors the respective electrical signals received from the track segments 16′. The device 50 may evaluate the received electrical signals to determine which, if any, of the track segments 16′ is broken, and communicate its findings to a control unit 52. Alternatively, the evaluation of the electrical signals may be performed by the control unit 52, in which case the device 50 may process the signals into a form suitable for receipt by the control unit. Alternatively still, the device 50 may be omitted and its functionality incorporated into the control unit 52.

In the illustrated embodiment, the device 50 is responsive to changes in the respective electrical properties, conveniently resistance, in each track segment 16′ to generate a signal indicating whether or not a respective track segment 16′ is deemed to be broken. This is indicative of whether or not the contents of the respective blister 12 have been dispensed. The control unit 52, which may take the form of a suitably programmed microprocessor, microcontroller or other processor, receives signals from the device 50. The control unit 52 may be programmed to record the time and/or date at which each track segment 16′ is deemed to be broken. The control unit 52 may also store data representing a regime (for example a regime for taking pills) and compare the information received from the device 50 against the regime data. Should the control unit 52 determine that an item was dispensed from its blister 12 at the wrong time, or not dispensed from its blister at the required time, then it may generate an alarm. The alarm may be audio and/or visual, and/or may involve recording the non-compliance in memory. Because the device 50 is able to monitor track segments 16′ individually, the control unit 52 is able to identify, record information and take any other necessary action in respect of each blister 12 individually.

An audio player 54 is connected to the control unit 52 for control thereby. The audio player 54 may be operated by the control unit 52 in response to determination that the regime has not been followed, and/or in response to a user input via one or more input buttons 42.

An interface device 56, for example a USB port, allows communication between the control unit 52 and an external computer.

1-23. (canceled)

24. A dispensing apparatus comprising a case and a removable package, the package comprising at least one compartment and a film of frangible material extending across an open mouth of the or each compartment in order to close the compartment, the film having an external face wherein at least one electrically conductive track is provided on the external face of the film and traverses at least partly across the or each compartment, the case including a connector for receiving said package and electrically connecting, when said package is received by said connector, said at least one conductive track to a monitoring system located in said case, said monitoring system being configured to monitor electrical signals received from said at least one conductive track, and to determine, from said electrical signals, whether or not said at least one compartment has been opened.

25. An apparatus as claimed in claim 24, wherein said at least one conductive track includes at least one electrical terminal for electrically connecting the respective conductive track to said monitoring system, said at least one electrical terminal being located substantially at an end of said package, and wherein said case is adapted to received said end of said package.

26. An apparatus as claimed in claim 25, wherein said at least one conductive track comprises a plurality of conductive track segments, each segment having a respective electrical terminal for electrically connecting the respective conductive track segment to said monitoring system, and wherein said respective electrical terminals are arranged substantially linearly with one another.

27. An apparatus as claimed in claim 24, wherein said package comprises a plurality of compartments and said at least one conductive track comprises a respective conductive track segment that at least partly traverses a respective compartment.

28. An apparatus as claimed in claim 27, wherein said at least one conductive track comprises a common terminal from which a common rail track segment emanates, and a respective branch track section emanating from the common rail segment to traverse a respective compartment, each branch segment having a respective terminal for connection to the electrical circuit.

29. An apparatus as claimed in claim 24, wherein at least one layer of electrically insulating material is provided between the film and said at least one conductive track.

30. An apparatus as claimed in claim 24, wherein at least one layer of electrically insulating material is provided on top of said at least one conductive track.

31. An apparatus as claimed in claim 24, wherein said at least one conductive track is formed from a flexible and frangible material.

32. An apparatus as claimed in claim 24, wherein said at least one conductive track is formed from conductive flexographic ink.

33. An apparatus as claimed in claim 29, wherein the, or each, insulating layer is preferably formed from insulating flexographic ink.

34. An apparatus as claimed in claim 28, wherein said connector includes a respective electrical terminal for the or each terminal of said at least one conductive track, said respective terminal of the connector electrically connecting the respective terminal of the conductive track to the monitoring system when the package is received by the connector.

35. An apparatus as claimed in claim 34, wherein said branch segments are electrically connected in parallel with one another when said package is received by said connector.

36. An apparatus as claimed in claim 24, wherein said monitoring system is configured to monitor one or more respective electrical signal received from each respective conductive track segment, and said monitoring system configured to determine whether or not said at least one compartment has been opened from said respective one or more electrical signal.

37. An apparatus as claimed in claim 27, wherein said monitoring system is configured to monitor, from said electrical signals, at least one electrical property, preferably electrical resistance, of said at least one conductive track.

38. An apparatus as claimed in claim 37, wherein said monitoring system is configured to monitor said at least one electrical property in respect of each of said conductive track segments.

39. An apparatus as claimed in claim 24, wherein said monitoring system is configured to record when the or each compartment is determined to have been opened.

40. An apparatus as claimed in claim 24, wherein said monitoring system is configured to compare when the or each compartment is determined to have been opened against a regime and to determine if said regime is adhered to.

41. An apparatus as claimed in claim 40, wherein said monitoring system, upon determining that said regime is not adhered to, is configured to generate an alarm.

42. An apparatus as claimed in claim 41, wherein said monitoring system is configured to generate an audio alarm and/or a visual alarm.

43. An apparatus as claimed in claim 24, wherein said monitoring system includes an audio player.

44. An apparatus as claimed in claim 24, wherein said connector is provided on a spine portion of the case, the case including first and second leaf portions coupled to the spine, the case being operable into and out of a closed state in which the package, when installed, is contained within the leaf portions.

45. An apparatus as claimed in claim 44, wherein, in an open state, said leaf portions are orientated with respect to the spine such that the obverse and reverse faces of the package are exposed.

46. An apparatus as claimed in claim 44, wherein each leaf portion is pivotably coupled to a respective side of the spine, the spine being substantially centrally located between the leaf portions.
